(19) United States
(12) Patent Application Publication
(10) Pub. No.: US 2015/0199298 A1
(43) Pub. Date: Jul. 16, 2015

(54) STORAGE AND NETWORK INTERFACE MEMORY SHARE

(71) Applicant: NetApp. Inc., Sunnyvale, CA (US)

(72) Inventors: Richard Strong, Pittsburgh, PA (US); George Totolos, Pittsburgh, PA (US)

(21) Appl. No.: 14/157,149

(22) Filed: Jan. 16, 2014

(51) Int. Cl. G06F 15/173; G06F 3/06

(52) U.S. Cl. CPC G06F 15/17331; G06F 3/061; G06F 3/0655; G06F 3/067

(57) ABSTRACT

A method of operating a storage system is disclosed. The method may include: receiving an I/O request through a network interface involving writing or retrieving a payload data from a storage system; communicating control information of the I/O request to a host processor system without communicating the payload data to the host processor system; receiving a storage access instruction from the host processor system to either retrieve the payload data or to write the payload data; accessing a storage device through a storage interface to execute the storage access instruction involving the payload data; and responding to the I/O request through the network interface without transferring the payload data to a host memory of the host processor system.

### TECHNOLOGY FIELD

At least one embodiment of the disclosure pertains to data storage systems, and more particularly, to network and storage interfaces of a storage system.

### BACKGROUND

In a typical storage system, there are a number of bottlenecks. These bottlenecks may exist in processing, in data transport, or in permanent or temporary data storage. Storage servers have host processors and host memory modules therein. The host processors used by the storage servers typically are connected to separate Peripheral Component Interconnect Express (PCIe) daughter cards for interfacing to a network (e.g., Ethernet) and storage devices (e.g., serial attached SCSI (SAS)), respectively.

A client machine may send requests and exchange data with the storage server using a network interface of the network daughter card. The storage server may respond to these requests by reading and writing data to/from storage devices using a storage interface of the storage daughter card. Inside the storage server, data travels from one daughter card, through the host processor and host memory module(s), to the other daughter card. The exchange and processing of data between the daughter cards can lead to bottlenecks in either or both of the host processor and the host memory module(s). For example, the host processor may load large amount of data structures related to a file system onto the host memory module(s) while the network daughter card is also transferring a large amount of payload received from the network to the host memory module(s). This creates a memory bottleneck in the storage server and can slow down the entire storage system.

### BRIEF DESCRIPTION OF THE DRAWINGS

FIG. 1 is a block diagram illustrating a system architecture of a conventional storage server.

FIG. 2 is a block diagram illustrating a system architecture of a storage server with a dual interface card, consistent with various embodiments.

FIG. 3 is a block diagram illustrating a system architecture of a storage system including a host storage server and an interface appliance, consistent with various embodiments.

FIG. 4 is a flow chart illustrating a process of processing a write request through a storage system with a dual interface device, consistent with various embodiments.

FIG. 5 is a flow chart illustrating a process of processing a read request through a storage system with a dual interface device, consistent with various embodiments.

FIG. 6 is a data flow diagram illustrating processing of a write request through a storage system with a dual interface device, consistent with various embodiments.

FIG. 7 is a data flow diagram illustrating processing of a read request through a storage system with a dual interface device, consistent with various embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The disclosed technology is directed to a storage system where a storage interface and a network interface have a channel to communicate datasets without having to first load the datasets to a host memory of a host server or involve a host processor of the host server during movement of payload data of I/O requests from one interface to another. The host server may be responsible for hosting a file system or a structured data storage system. The host server includes a host processor system including one or more host processors. The host memory includes one or more host memory modules.

In one embodiment, the host server includes both a network interface and a storage interface on a single dual interface daughter card coupled to the host processor system, e.g., coupled through a PCIe interface. The dual interface daughter card establishes the channel to communicate datasets between the storage interface and the network interface without loading the datasets to the host memory. Data can be exchanged between the network interface and the storage interface using a local memory of the dual interface card, such that the host memory is not involved in the bulk of the transfer. Optionally, the dual interface card may offload some of the data processing from the host processor system as well. The local memory may be a single shared memory space. Alternatively, the local memory may include a portion allocated for incoming data through the storage interface and a portion allocated for incoming data through the network interface.

In another embodiment, the host server is coupled to an external appliance. The external appliance can include both a network interface and a storage interface. Similar to the dual interface daughter card, the external appliance manages both interfaces for the host storage server. When responding to read/write requests to the network interface, the external appliance can maintain a large portion of incoming and outgoing data through the storage devices and the network in the external appliance without having to transfer the data over to the host memory.

In some embodiments, the channel to communicate datasets without having to first load the datasets to the host memory is accomplished without placing the network interface and the storage interface in a single device. For example, a protocol for direct communication between a storage daughter card and a network daughter card can be established. When responding to a read/write request, portions of incoming and outgoing data from the storage devices and the network can remain in the daughter cards without being first loaded onto the host memory. As another example, a protocol for direct communication between an external storage appliance and an external network appliance can be established. When responding to a read/write request, portions of incoming and outgoing data from the storage devices and the network can remain in the external appliances without being first loaded onto the host memory.

The embodiments and implementations described in this disclosure enables a channel between the storage interface and the network interface to reduce memory bottleneck that can occur in the host memory. Further, because of a shared memory space for both the storage interface and the network interface, a dual interface processing system can further reduce computational bottlenecks that may occur on the host processor system. Compared to the conventional storage server setup, the disclosed technology increases throughput for data exchange through both network and storage.

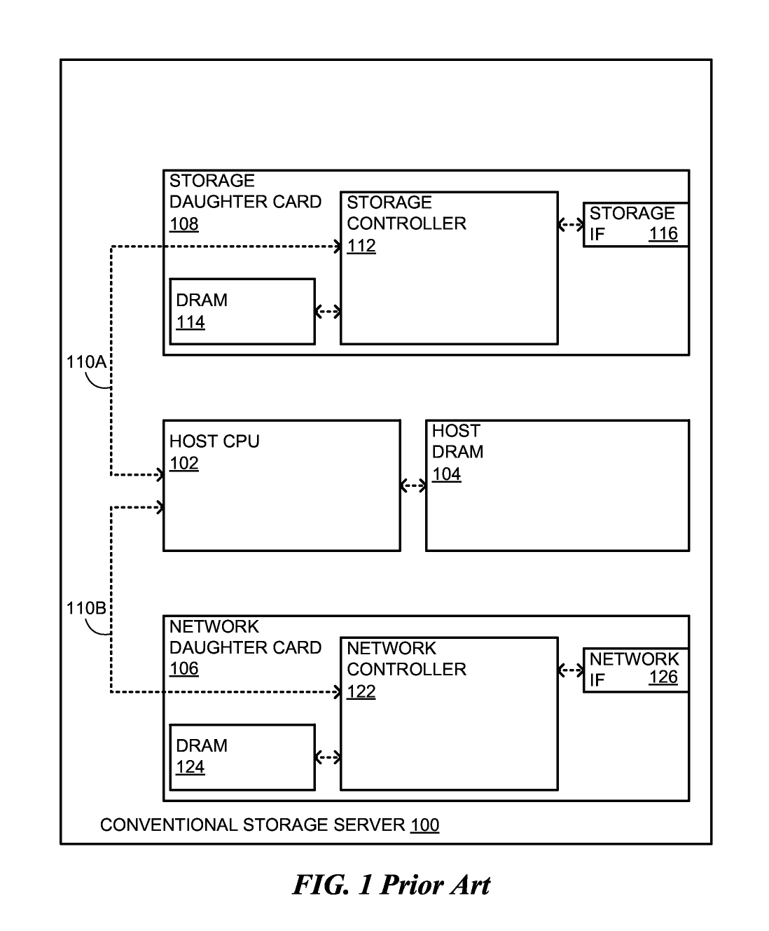

FIG. 1 is a block diagram illustrating a system architecture of a conventional storage server 100. The conventional storage server 100 includes a host central processing unit (CPU) 102 and a host dynamic random-access memory (DRAM) 104. The host CPU 102 is coupled to a network daughter card 106 and a storage daughter card 108. Typically, the storage daughter card 108 can be connected to the host CPU 102 through a first PCIe bus 110A and the network daughter card 106 can be connected to the host CPU 102 through a second PCIe bus 110B.

The storage daughter card 108 includes a storage controller 112, a storage card DRAM 114, and a storage interface 116. The storage interface 116 is connected to one or more storage devices, e.g., hard disk drives, solid state drives, flash drives, tape drives or other types of persistent storage. The storage controller 112 is configured to process messages to and from the storage devices through the storage interface 116. The storage card DRAM 114 is for storing incoming or outgoing data through the storage interface 116. Whenever the storage controller 112 executes a command to transfer data out through a network connected to the network daughter card 106, the data is first sent to the host CPU 102 and stored in the host DRAM 104 before forwarding the command to the network daughter card 106.

The network daughter card 106 includes a network controller 122, a network card DRAM 124, and a network interface 126. The network interface 126 is connected to a network, e.g., wired or a wireless network. The network controller 122 is configured to process messages to and from the network through the network interface 126. The network card DRAM 124 is for storing incoming or outgoing data through the network interface 126. Whenever a message (e.g., a write request) includes a command to access a storage device connected to the storage daughter card 108, incoming payload data is first sent to the host CPU 102 and stored in the host DRAM 104 before relaying the message to the storage daughter card 108.

For example, when a write request arrives at the network interface 126, payload data and control information of the write request are stored in the network card DRAM 124. Then both the payload data and the control information are transferred to the host CPU 102 and stored in the host DRAM 104. The host CPU 102 then processes the control information to determine specific instructions for the storage devices, and sends the payload data to the storage daughter card 108 for storage. The payload data is then again stored in the storage card DRAM 114. Under this conventional system architecture, the payload data is redundantly stored in at least three separate memory devices.

For another example, when a read request arrives at the network interface 126, control information for the read request is passed from the network controller 122 to the host CPU 102 and then to the storage controller 112. The storage controller 112 retrieves the requested data through the storage interface 116 connected to the storage devices. The requested data is stored first in the storage card DRAM 112 then transferred to the host CPU 102 and stored in the host DRAM 104. The host CPU 102 then forwards the requested data to the network daughter card 106. The network controller 122 stores the requested data temporarily in the network DRAM 124 before transmitting the requested data to a requesting client through the network interface 126. Again under this conventional system architecture, the requested data is redundantly stored in at least three separate memory devices.

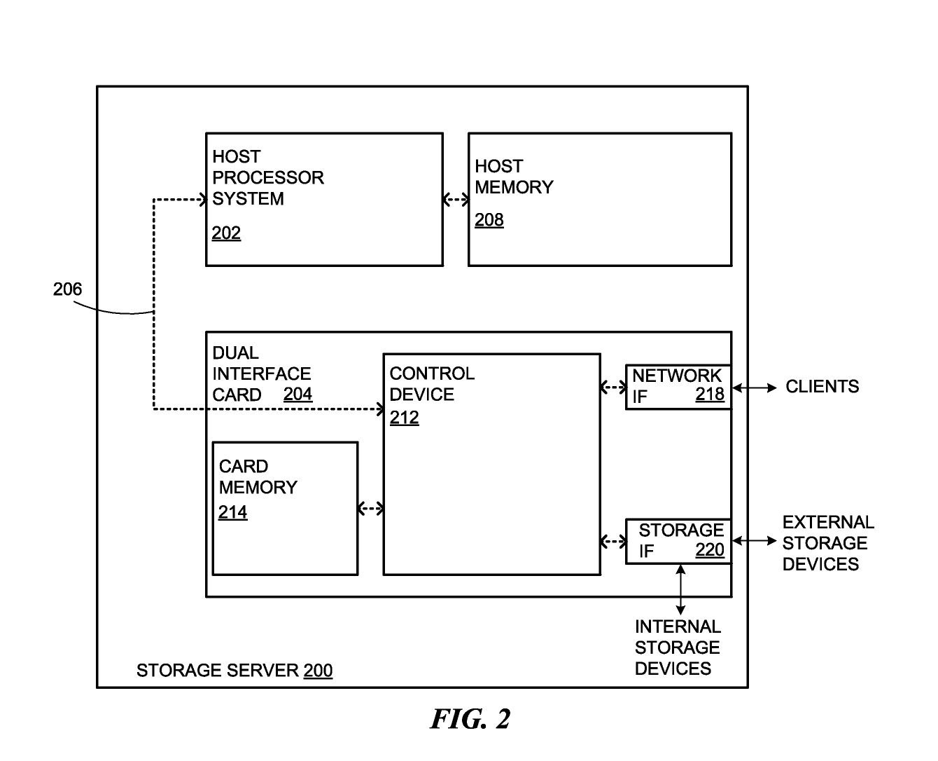

FIG. 2 is a block diagram illustrating a system architecture of a storage server 200 with a dual interface card 204, consistent with various embodiments. The storage server 200 includes a host processor system 202, which includes one or more processors. The dual interface card 204 may be connected to the host processor system 202 through a system interconnect 206, e.g., a PCI or PCIe connection. The dual interface card 204 may be a daughter card of the host processor system 202. The host processor system 202 is also connected to a host memory 208. The host memory 208 includes one or more memory modules, e.g., DRAM or other volatile memory modules.

The dual interface card 204 includes a control device 212, a card memory 214, a network interface 218, and a storage interface 220. The control device 212 may be one or more of a processor, a field programmable gate array (FPGA), an application specific integrated circuit (ASIC), or other types of controller. The card memory 214 may be volatile memory, e.g., DRAM module(s), or non-volatile memory, e.g., solid state memory module(s). The network interface 218 is connected to one or more external networks, either via a wired connection or a wireless connection. The storage interface 220 is connected to one or more storage devices, including a hard disk drive, a flash drive, a solid-state drive, a tape drive, other persistent storage device, or any combination thereof. The network interface 218 and the storage interface 220 are connected (directly or indirectly) to the control device 212. The network interface 218 and the storage interface 220 may also be connected (directly or indirectly) to the card memory 214 (not shown).

The dual interface card 204 may be a replacement of the network daughter card 106 and the storage daughter card 108 of FIG. 1. For example, when a write request arrives at the network interface 218, payload data and/or control information of the write request are stored in the card memory 214. The control information is transferred to the host processor system 202 to be processed. A link to the payload data stored in the card memory 214 may be sent to the host processor system 202. In various embodiments, either a portion (i.e., not the whole) of the payload data or none of the payload data is sent to the host processor system 202. For example, the control information of the write request may specify which portion of the payload data to send to the host processor system 202. The host processor system 202 then processes the control information to determine specific instruction(s) for the one or more storage devices connected through the storage interface 220. The specific instruction(s) is sent to the control device 212 of the dual interface card 204. In response to the specific instruction(s), the control device 212 sends the payload data through the storage interface 220 to the one or more storage devices according to the specific instruction(s). Under the disclosed system architecture with the dual interface card 204, the payload data is no longer redundantly stored, and is only stored in the card memory 214 (i.e., not store in the host memory 208) throughout the write request process.

For another example, when a read request arrives at the network interface 218, control information is passed from the controller device 212 to the host processor system 202 to determine specific instruction(s) to retrieve requested data from the one or more storage devices and to send the requested data to a particular client over the network. The host processor system 202 responds by sending the specific instruction(s) to the control device 212. In response to receiving the specific instruction(s), the control device 212 can retrieve the requested data from the one or more storage devices. Once retrieved, the requested data can be stored in the card memory 214. According to the specific instruction(s) from the host processor system 202, the control device 212 then sends the requested data through the network interface 218 to the particular client over the network. Under the disclosed system architecture with the dual interface card 204, the requested data is no longer redundantly stored, and is only stored in the card memory 214 (i.e., not store in the host memory 208) throughout the read request process.

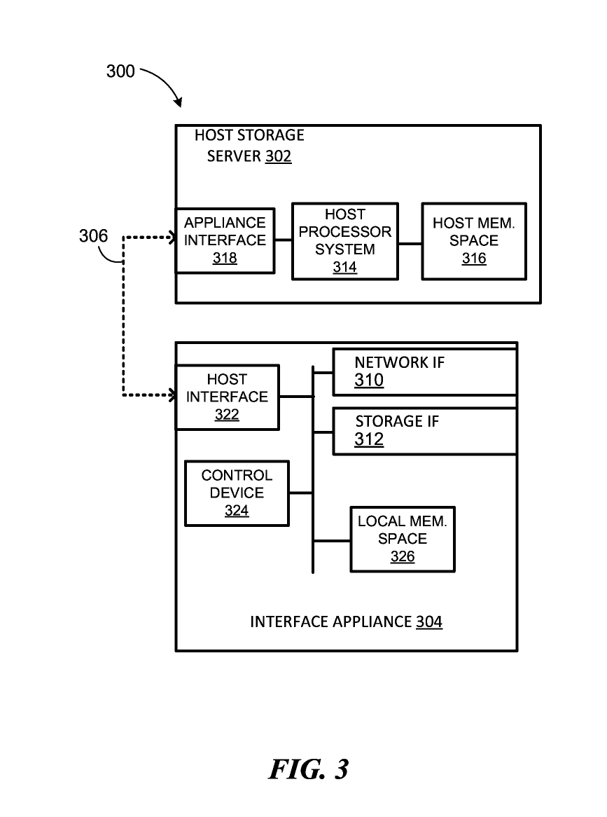

FIG. 3 is a block diagram illustrating a system architecture of a storage system 300 including a host storage server 302 and an interface appliance 304, consistent with various embodiments. The host storage server 302 is a storage server for managing a file system or a structured data storage system. The host storage server 302 is coupled to the interface appliance 304 through a control bus 306. For example, the control bus 306 may be a storage bus (e.g., Serial Advanced Technology Attachment (SATA) cable, Ethernet cable, PCIe cable, optical fiber cable, or other communication interconnect). The interface appliance 304 includes both a network interface 310 and a storage interface 312.

The host storage server 302 includes a host processor system 314 and a host memory space 316. The host processor system 314 is a system of one or more processors. The host memory space 316 is a memory space implemented by one or more memory modules, e.g., DRAM or other volatile memory. The host storage server 302 includes an appliance interface 318 for coupling with the control bus 306. The appliance interface 318 can relay messages from the interface appliance 304 to the host processor system 314 and relay messages from the host processor system 314 to the interface appliance 304. Optionally, the appliance interface 318 can have a connection with the host memory space 316. In some embodiments, the appliance interface 318 can share a connection to the host processor system 314 as the host memory space 316.

The interface appliance 304 includes a host interface 322 receiving the control bus 306 connecting the host storage server 302 and the interface appliance 304. The host interface 322 enables a control device 324 of the interface appliance 304 to communicate with the host storage server 302, particularly the host processor system 314. The interface appliance 304 further includes a local memory space 326 for storing incoming or outgoing data from the network interface 310 or the storage interface 312. The local memory space 326 may be volatile memory, e.g., DRAM module(s), or non-volatile memory, e.g., solid state memory module(s). The host interface 322, the local memory space 326, the network interface 310, and the storage interface 312 can individually have a connection with the control device 324. Alternatively, two or more of the host interface 322, the local memory space 326, the network interface 310, and the storage interface 212 can share a connection with the control device 324.

The interface appliance 304 may be a replacement in functionalities to the network daughter card 106 and the storage daughter card 108 of FIG. 1. For example, when responding to a write request or a read request arriving through the network interface 310, the control device 324 can respond in a similar fashion as described for the control device 212 of FIG. 2.

Payload data and/or control information of a write request are stored in the local memory space 326. The control information (e.g., only the control information) is transferred to the host processor system 314 to be processed. A link to the payload data stored in the local memory space 326 may also be sent to the host processor system 314. In various embodiments, either a portion (i.e., not the whole) of the payload data or none of the payload data is sent to the host processor system 314. For example, the control information of the write request may specify which portion of the payload data to forward to the host processor system 314. The host processor system 314 then processes the control information to determine specific instruction(s) for the one or more storage devices connected through the storage interface 312. The specific instruction(s) is sent to the control device 324. In response to the specific instruction(s), the control device 324 sends the payload data through the storage interface 312 to the one or more storage devices according to the specific instruction(s). Under the disclosed system architecture of the interface appliance 304, the payload data is no longer redundantly stored, and is only stored in the local memory space 326 (i.e., not store in the host memory space 316) throughout the write request process.

For another example, when responding to a read request arriving at the network interface 310, control information is passed from the controller device 324 to the host processor system 314 to determine specific instruction(s) to retrieve requested data from the one or more storage devices and to send the requested data to a particular client over the network. The host processor system 314 responds by sending the specific instruction(s) to the control device 324. In response to receiving the specific instruction(s), the control device 324 can retrieve the requested data from the one or more storage devices. Once retrieved, the requested data can be stored in the local memory space 326. According to the specific instruction(s) from the host processor system 314, the control device 324 then sends the requested data through the network interface 310 to the particular client over the network. Under the disclosed system architecture of the interface appliance 304, the requested data is no longer redundantly stored, and is only stored in the local memory space 326 (i.e., not store in the host memory space 316) throughout the read request process.

Blocks, components, and/or modules associated with the storage server 200 and the storage system 300 may be implemented as hardware modules or a combination of hardware and software modules. Controlling modules may be operable as a processor or other computing device, e.g., a single board chip, application specific integrated circuit, or a field programmable field array.

Each of the modules may operate individually and independently of other modules. Some or all of the modules may be executed on the same host device or on separate devices. The separate devices may be coupled via a communication module to coordinate its operations via a wired interconnect or wirelessly. Some or all of the modules may be combined as one module.

A single module may also be divided into sub-modules, each sub-module performing separate method step or method steps of the single module. In some embodiments, the modules can share access to a memory space. One module may access data accessed by or transformed by another module. The modules may be considered “coupled” or capable of communicating with one another if they share a physical connection or a virtual connection, directly or indirectly, allowing data accessed or modified from one module to be accessed in another module. The storage server 200 and/or the storage system 300 may include additional, fewer, or different modules for various applications.

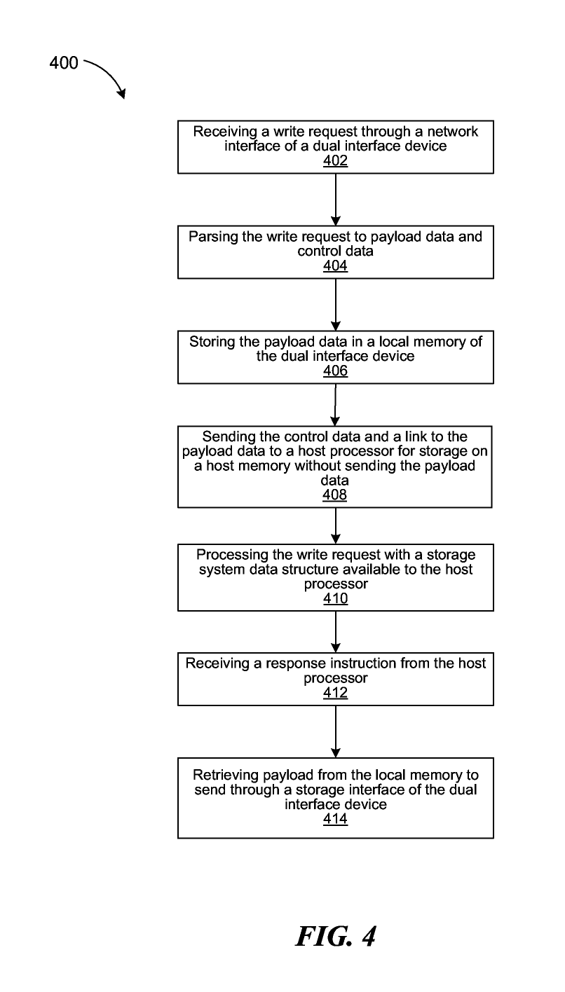

FIG. 4 is a flow chart illustrating a process 400 of processing a write request through a storage system with a dual interface device, consistent with various embodiments. For example, the storage system may be the storage server 200 of FIG. 2 or the storage system 300 of FIG. 3. The process 400 begins with receiving a write request through a network interface of a dual interface device in step 402. The network interface may be the network interface 218 of FIG. 2 or the network interface 310 of FIG. 3. The dual interface device may be the dual interface card 204 of FIG. 2 or the interface appliance 304 of FIG. 3. The write request can come from a client device across a network connected to the network interface.

Then in step 404, a controller (e.g., a processor or other control device) of the dual interface device can parse the write request to payload data and control data. The controller may be the control device 212 of FIG. 2 or the control device 324 of FIG. 3. For example, the control data may be parsed from either a header or a trailer of a network packet(s) of the write request. The payload data is stored in a local memory of the dual interface device in step 406 and the control data is sent to a host processor in step 408. The local memory may be the card memory 214 of FIG. 2 or the local memory space 326 of FIG. 3. The host processor may be the host processer system 202 of FIG. 2 or the host processor system 314 of FIG. 3. In various embodiments, while the control data is sent to the host processor, the payload data is not entirely or at all sent to the host processor. In some embodiments, only the control data is sent to the host processor. In other embodiments, the control data and a link to the payload data is sent to the host processor. In yet other embodiments, the control data and a selected portion (i.e., not the whole) of the payload data is sent to the host processor. The control data, the selected portion, and/or the link to the payload data can be stored on a host memory for the host processor, e.g., the host memory 208 of FIG. 2 or the host memory space 316 of FIG. 3.

In step 410, the host processor processes the write request referencing a storage system data structure(s) (e.g., file object namespace, storage object metadata, or data block metadata) available to the host processor (e.g., stored in the host memory or on a persistent storage directly available to the host processor). The storage system data structure may be data and/or metadata related to data objects and data blocks of the storage system. Then in step 412, the dual interface device can receive a response instruction from the host processor. The host processor can generate and send the response instruction, in response to processing the write request with the control data and/or the storage system data structure (e.g., as in step 410). The response instruction may indicate where and how to store the payload data into one or more storage devices accessible to a storage interface of the dual interface device. For example, the storage interface may be the storage interface 220 of FIG. 2 or the storage interface 312 of FIG. 3. In response to the response instruction, the controller of the dual interface device retrieves the payload data from the local memory to send through the storage interface for writing to the one or more storage devices according to the response instruction in step 414.

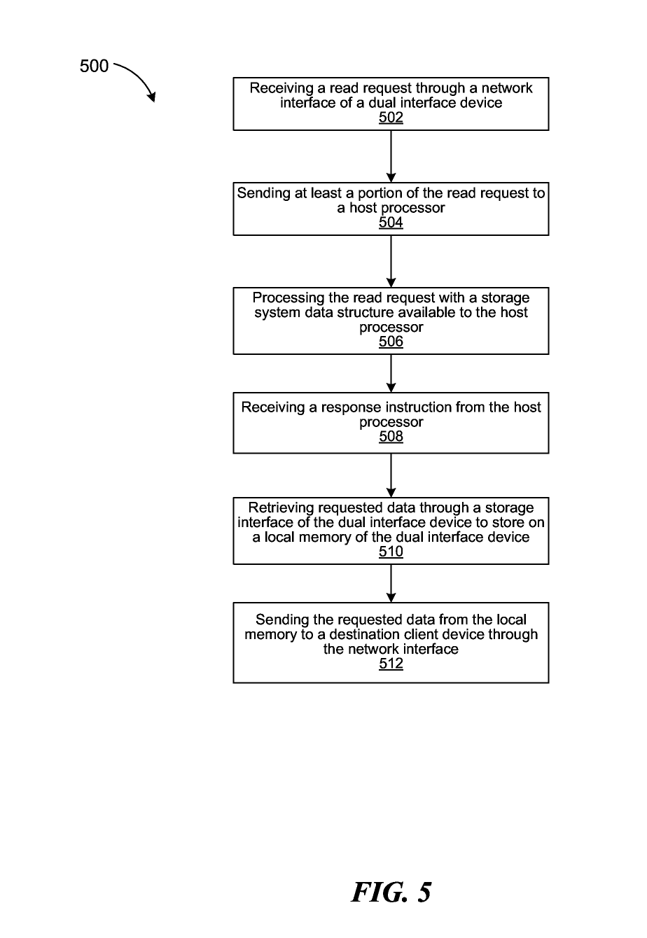

FIG. 5 is a flow chart illustrating a process 500 of processing a read request through a storage system with a dual interface device, consistent with various embodiments. For example, the storage system may be the storage server 200 of FIG. 2 or the storage system 300 of FIG. 3. The process 500 begins with receiving a read request through a network interface of a dual interface device in step 502. The network interface may be the network interface 218 of FIG. 2 or the network interface 310 of FIG. 3. The dual interface device may be the dual interface card 204 of FIG. 2 or the interface appliance 304 of FIG. 3. The read request may come from a client device across a network connected to the network interface.

Then in step 504, a controller (e.g., a processor or other control device) of the dual interface device can send at least a portion of the read request to a host processor. For example, the at least a portion of the read request can include control data of the read request or constitute the entirety of the read request. The controller may be the control device 212 of FIG. 2 or the control device 324 of FIG. 3. For example, the control data may be parsed from either a header or a trailer of a network packet(s) of the read request. The host processor may be the host processer system 202 of FIG. 2 or the host processor system 314 of FIG. 3.

In step 506, the host processor processes the read request with a storage system data structure(s) (e.g., file object namespace, storage object metadata, or data block metadata) available to the host processor (e.g., stored on a host memory of the host processor or on a persistent storage directly available to the host processor). The storage system data structure may be data and/or metadata related to data objects and data blocks of the storage system. Then in step 508, the dual interface device can receive a response instruction from the host processor. The host processor can generate and send the response instruction, in response to processing the read request with the control data and/or the storage system data structure (e.g., as in step 506). The response instruction may indicate where to retrieve the requested data as indicated in the read request from one or more storage devices accessible to a storage interface of the dual interface device. The response instruction may also indicate how to respond back to the client device with the requested data indicated in the read request. For example, the storage interface may be the storage interface 220 of FIG. 2 or the storage interface 312 of FIG. 3.

In response to the response instruction, the controller of the dual interface device retrieves the requested data through the storage interface to store on a local memory of the dual interface device in step 510. The local memory may be the card memory 214 of FIG. 2 or the local memory space 326 of FIG. 3. The requested data is then sent from the local memory to a destination client device through the network interface in step 512. The destination client device may be the client device that originated the read request or another device indicated by the read request and/or the response instruction. In various embodiments, the controller can directly instruct the network interface to send out the requested data without first sending the requested data to the host processor. In some embodiments, a link to the requested data is sent to the host processor for processing.

While processes or blocks are presented in a given order in FIGS. 4 and 5, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

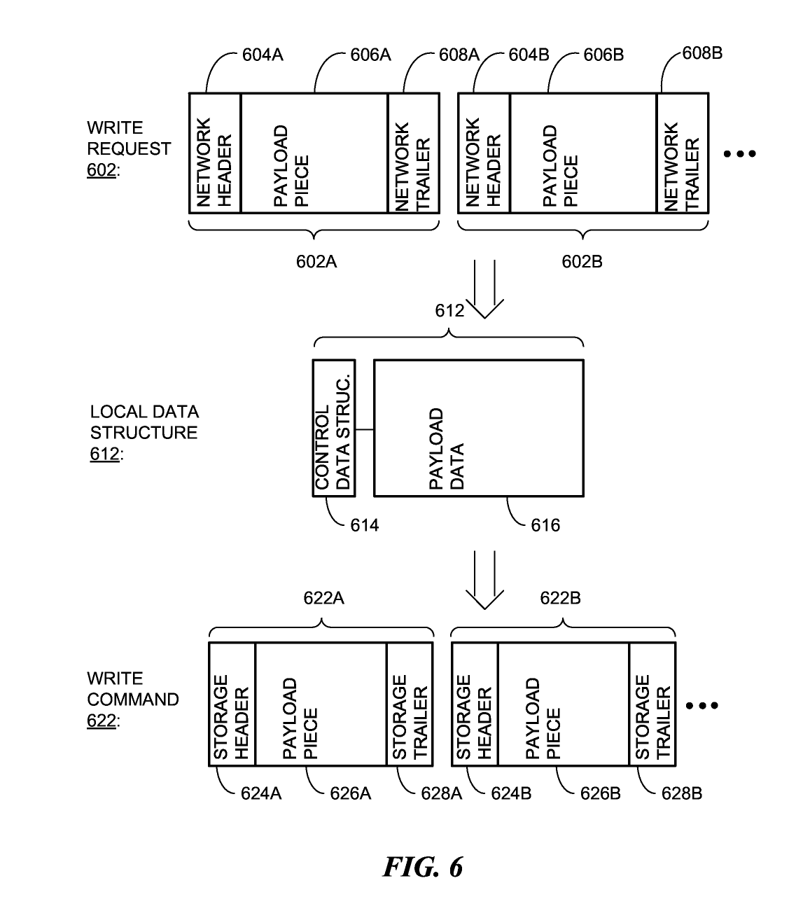

FIG. 6 is a data flow diagram illustrating processing of a write request 602 through a storage system with a dual interface device, consistent with various embodiments. For example, the storage system may be the storage server 200 of FIG. 2 or the storage system 300 of FIG. 3. The write request 602 may arrive through a network interface in the dual interface device, e.g., the network interface 218 of the dual interface card 204 of FIG. 2 or the network interface 310 of the interface appliance 304 of FIG. 3. The write request 602 may include one or more write request packets, e.g., a first write request packet 602A and a second write request packet 602B, collectively as the “write request 602.” Each of the write request packets includes a network header (e.g., a first network header 604A or a second network header 604B, collectively as “network headers 604”). Each of the write request packets also includes a portion of a payload data (e.g., a first payload data piece 606A or a second payload data piece 606B, collectively as the “payload data pieces 606”). Each of the write request packets further includes a network trailer (e.g., a first network trailer 608A or a second network trailer 608B, collectively as “network trailers 608”).

Control data may be stored in the network headers 604. For example, the control data may include who is sending the write request, what data object(s) or data container(s) the write request is related to, security information of the write request, scheduling and other timing information related to the write request, or any combination thereof. In some embodiments, the control data may also be stored in the network trailers 608. The payload data pieces 606 include digital bits representing the data to be written to one or more storage devices in the storage system.

After the write request 602 is processed by a controller (e.g., the control device 212 of FIG. 2 or the control device 324 of FIG. 3) of the dual interface device, the controller can generate a local data structure 612 for processing the write request 602. The local data structure 612 is stored on a local memory of the dual interface device. The local memory may be the card memory 214 of FIG. 2 or the local memory space 326 of FIG. 3. The local data structure 612 includes a control data structure 614 and a payload data 616. The control data structure 614 may reference the payload data 616, the payload data 616 may reference the control data structure 614, or both can reference each other. The control data structure 614 may be extracted from the network headers 604 of the write request 602. The payload data 616 may be a combination of the payload data pieces 606 of the write request 602.

After a response instruction is received at the controller of the dual interface device (e.g., as in step 412 of FIG. 4), the controller can generate a write command 622 comprising command packets (e.g., a first command packet 622A and a second command packet 622B, collectively as the “write command 622”) for a storage interface. For example, the storage interface may be the storage interface 220 of FIG. 2 or the storage interface 312 of FIG. 3. The write command 622 enables the storage interface to deliver the whole or portions of the payload data 616 to one or more storage devices connected to the storage interface.

Each of the command packets includes a storage header (e.g., a first storage header 624A or a second storage header 624B, collectively as “storage headers 624”). Each of the command packets also includes a portion of the payload data 616 (e.g., a first payload data piece 626A or a second payload data piece 626B, collectively as the “payload data pieces 626”). In some embodiments, the payload data pieces 626 may correspond to the payload data pieces 606. In other embodiments, the payload data pieces 626 do not correspond to the payload data pieces 606. Each of the command packets further includes a storage trailer (e.g., a first storage trailer 628A or a second storage trailer 628B, collectively as “storage trailers 628”). Either or both of the storage headers 624 or the storage trailers 628 may include information indicating where and how the payload data pieces 606 are to be written to the one or more storage devices.

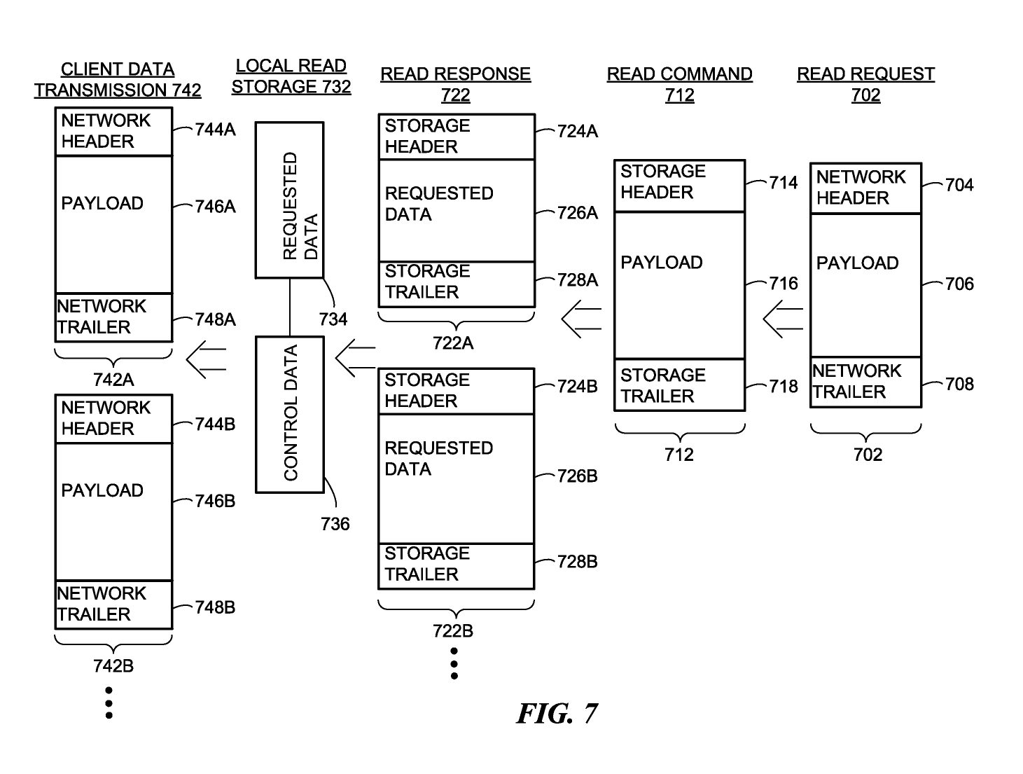

FIG. 7 is a data flow diagram illustrating processing of a read request through a storage system with a dual interface device, consistent with various embodiments. For example, the storage system may be the storage server 200 of FIG. 2 or the storage system 300 of FIG. 3. The read request 702 can arrive through a network interface in the dual interface device, e.g., the network interface 218 of the dual interface card 204 of FIG. 2 or the network interface 310 of the interface appliance 304 of FIG. 3. The read request 702 may be represented as a network packet. In some embodiments, the read request 702 may comprise multiple network packets (not shown), similar to the write request 602 of FIG. 6. The read request 702 includes a network header 704. Control data of the read request 702 may be stored in the network header 704. The read request 702 may include a payload data 706. The payload data 706 may be nil (i.e., empty) since generally there is no data transferred from a read request other than control data. In some embodiments, the control data may be stored in the payload data portion 706 of the read request 702. The read request 702 further includes a network trailer 708 indicating the end of the network packet of the read request 702.

Control data may be stored in the network header 704. For example, the control data may include who is sending the read request, what data object(s) or data container(s) the read request is related to, security information of the read request, scheduling and other timing information related to the read request, or any combination thereof. In some embodiments, the control data may also be stored in the network trailer 708 or the payload data portion 706.

After a response instruction is received at the controller of the dual interface device (e.g., as in step 508 of FIG. 5), the controller can generate a read command 712 for a storage interface. The read command 712 may be represented as a single storage packet. In some embodiments, the read command 712 may comprise multiple storage packets (not shown), similar to the write command 622 of FIG. 6. For example, the storage interface may be the storage interface 220 of FIG. 2 or the storage interface 312 of FIG. 3. The read command 712 enables the storage interface to retrieve requested data of the read request 702 from one or more storage devices connected to the storage interface.

The read command 712 includes a storage header 714, a payload data 716, and a storage trailer 718. Control data of the read command 712 may be stored in the storage header 714. Alternatively, the control data may be stored in the payload data portion 716 of the read command 712 or the storage trailer portion 718 of the read command 712. The control data may include information indicating where and how the data requested may be retrieved from the one or more storage devices.

In response to executing the read command 712 through the storage interface, the storage interface may return with a read response 722 to the controller of the dual interface device. The read response 722 includes one or more storage packets (e.g., a first storage packet 722A and a second storage packet 722B, collectively as the read response 722). Each of the storage packets of the read response 722 includes a storage header (e.g., a first storage header 724A or a second network header 724B, collectively as “storage headers 724”). Each of the storage packets of the read response 722 also includes a portion of the requested data (e.g., a first data piece 726A or a second data piece 726B, collectively as the “requested data pieces 726”). Each of the storage packets of the read response 722 further includes a storage trailer (e.g., a first storage trailer 728A or a second storage trailer 728B, collectively as “storage trailers 728”).

The storage headers 724 may include control information originating from the storage devices. The requested data pieces 726 in combination represents the requested data as indicated in the read request 702 for transmitting out to a destination client device. The storage trailers 728 may indicate the end of each storage packet. The storage headers 724 may differ from the storage header 714 of the read command 712. The storage trailers 728 may also differ from the storage trailer 718 of the read command 712.

In response to receiving the read response 722, the controller of the dual interface device can temporarily store data collected from the read response 722 in a local read storage 732. Requested data 734, consisting of the requested data pieces 726, may be stored in the local read storage 732. Control data 736 may also be stored in the local read storage 732. The control data 736 includes storage system metadata of the requested data, I/O related information, source and destination information, or any combination thereof. The control data 736 may reference the requested data 734, the requested data 734 may reference the control data 736, or both can reference each other. The control data 736 may be extracted from the network header 704 of the read request 702 and/or the storage headers 724 of the read response 722.

In some embodiments, the controller generates a client data transmission 742, in response to receiving the read response 722 through the storage interface without first storing the requested data 734 in the local read storage 732. In other embodiments, the client data transmissions 732 may be generated asynchronous to receipt of the read response 722. For example, the requested data 734 is first stored in the local read storage 732 before being used to generate the client data transmission 742.

The client data transmission 742 comprises network transmission packets (e.g., a first network packet 742A and a second network packet 742B, collectively as the “client data transmission 742”) for the network interface. The client data transmission 742 enables the network interface to deliver the requested data 734 to one or more storage devices connected to the storage interface.

Each of the network transmission packets includes a network header (e.g., a first network header 744A or a second network header 744B, collectively as “network headers 744”). Each of the network packets also includes a portion of the requested data 734 (e.g., a first payload data piece 746A or a second payload data piece 746B, collectively as the “payload data pieces 746”). In some embodiments, the payload data pieces 746 may correspond to the requested data pieces 726. In other embodiments, the payload data pieces 746 do not correspond to the requested data pieces 726 and are partitioned differently from the requested data 734. Each of the network packets further includes a network trailer (e.g., a first network trailer 748A or a second network trailer 748B, collectively as “network trailers 748”). Either or both of the network headers 744 or the network trailers 748 can include information indicating where and how the payload data pieces 746 are to be delivered to the destination client device across a network connected to the network interface.

What is claimed is:

1. A method comprising:
receiving an I/O request through a network interface involving writing or retrieving payload data from a storage system;
communicating control information of the I/O request to a host processor system without communicating the payload data to the host processor system;
receiving a storage access instruction from the host processor system to either retrieve the payload data or to write the payload data;
accessing a storage device through a storage interface to execute the storage access instruction involving the payload data; and
responding to the I/O request through the network interface without transferring the payload data to a host memory of the host processor system.

2. The method of claim 1, wherein the network interface and the storage interface reside on a single device sharing a local memory space separate from the host memory used by the host processor, and wherein the local memory is utilized to store the payload data as an intermediary storage of data transferring directly between the storage interface and the network interface.

3. The method of claim 2,
wherein receiving the I/O request includes receiving a read request;
wherein accessing the storage device through the storage interface includes retrieving the payload data from the storage device through the storage interface to be stored in the local memory; and
wherein responding to the I/O request includes responding by sending the stored payload data in the local memory through the network interface.

4. The method of claim 2,
wherein receiving the I/O request includes receiving a write request and storing the payload data from the write request in the local memory;
wherein receiving the storage access instruction includes receiving a response instruction to write the stored payload data to the storage device through the storage interface; and
wherein accessing the storage device through the storage interface includes writing the stored payload data through the storage interface.

5. The method of claim 2, wherein the network interface and the storage interface reside in a daughter component card serving the host processor.

6. The method of claim 2, wherein the network interface and the storage interface reside in an appliance separate from a host server hosting the storage system, the host server including the host processor and the host memory.

7. The method of claim 1, wherein the network interface resides on a network interface device and the storage interface resides on a storage interface device, both serving the host processor; and further comprising communicating the payload data between the network daughter card and the storage daughter card without going through the host processor.

8. A method of operating a storage system comprising:
receiving a write request for the storage system including control data and a payload data through a network interface of a dual interface device;
storing the payload data in a local memory of the dual interface device;
communicating the control data of the write request to a host processor system from the dual interface device, the host processor system for managing the storage system;
receiving a storage access instruction from the host processor system; and
generating a storage command based on the storage access instruction including sending the stored payload data from the local memory through a storage interface.

9. The method of claim 8, wherein communicating the control data includes communicating the control data without communicating the payload data to the host processor system and without storing the payload data in a host memory of the host processor system.

10. The method of claim 8, wherein communicating the control data includes communicating the control data with a link to the payload data stored in the local memory.

11. The method of claim 8, further comprising parsing the write request, represented as network packets, to identify the control data and the payload data.

12. A method of operating a storage system comprising:
receiving a read request for the storage system through a network interface of a dual interface device, the read request including identifying information of requested data;
communicating at least the identifying information of the requested data to a host processor system for managing the storage system;
receiving a storage access instruction from the host processor system;
executing the storage access instruction to retrieve the requested data through a storage interface of the dual interface device; and
generating a network data transmission from the requested data to send through the network interface to respond to the read request.

13. The method of claim 12, further comprising storing the requested data in a local memory of the dual interface device; and wherein generating the network data transmission includes generating the network data transmission in the dual interface device from the requested data stored in the local memory.

14. The method of claim 12, wherein during execution of the method of claim 12, the requested data is not ever entirely communicated to the host processor system.

15. A dual interface device for a storage system comprising:
a network interface to communicate through a network with a client device;
a storage interface to communicate with a storage device of the storage system;
a host interface for communicating with a host processor system hosting the storage system;
a local memory to store I/O payload from the network interface and from the storage device; and
a control device, coupled to the host interface, the local memory, the storage interface, and the network interface, configured to communicate control data of I/O requests from the network interface to the host processor system through the host interface and to execute a storage access instruction from the host processor system through the storage interface.

16. The dual interface device of claim 15, wherein the dual interface device is a daughter card of the host processor system and the host interface is for connecting with a component interconnect of the host processor system.

17. The dual interface device of claim 15, wherein the dual interface device is an external appliance separate from a host server housing the host processor system and the host interface is for connecting with a control bus connecting with the host server.

18. The dual interface device of claim 15, wherein the control device is configured to receive a write request through the network interface and to store the I/O payload of the write request in the local memory; and wherein the control device is further configured to request the storage access instruction involving the write request from the host processor system by sending control data parsed from the write request without sending the I/O payload through the host interface.

19. The dual interface device of claim 15, wherein the control device is configured to receive a read request through the network interface and to request the storage access instruction from the host processor system involving the read request; and wherein the control device is further configured to retrieve the I/O payload by executing the storage access instruction through the storage interface and to generate and send a network data transmission including the I/O payload without communicating the retrieved I/O payload through the host interface.

20. The dual interface device of claim 15, wherein the dual interface device is not configured to store metadata of the storage system; and wherein the control device is configured to access metadata of the storage system only through the host processor system.
